(19) United States
(12) Patent Application Publication
(10) Pub. No.: US 2021/0394958 A1
(43) Pub. Date: Dec. 23, 2021

(54) TOTE SYSTEM FOR FACILITATING RETAIL PICK-UP ORDERS

(71) Applicant: H-E-B, LP, San Antonio, TX (US)

(72) Inventors: Johanna Stechschulte, Canyon Lake, TX (US); Jin Li, San Antonio, TX (US); Gene Valdivieso, San Antonio, TX (US); Coryna Lynn Hinojosa, San Antonio, TX (US); Brian Kinderknecht, Schertz, TX (US); Samuel Letzerich, San Antonio, TX (US); Kedar Patel, San Antonio, TX (US); Craig T. Reali, Garden Ridge, TX (US)

(21) Appl. No.: 16/904,429

(22) Filed: Jun. 17, 2020

(51) Int. Cl. B65D 21/06; B65D 21/04

(52) U.S. Cl. CPC B65D 21/068; B65D 21/086; B65D 21/048

(57) ABSTRACT

A tote and tote system providing for more efficient retail order pick-ups is disclosed. In certain embodiments, a tote may comprise a bottom panel for supporting one or more retail items, a rear panel and a front panel, wherein the front panel comprises an opening for accessing the one or more retail items of the tote, a first and a second side panel, and one or more bale arms positioned across a top of the tote, wherein the one or more bale arms each comprise a substantially horizontal portion extending from the first side panel to the second side panel, such that the one or more bale arms are operable to support another tote stacked on top of the tote.

### BACKGROUND

The present disclosure generally relates to systems and methods for fulfilling orders for items sold by retailers, and more particularly, to a novel tote and tote system for facilitating retail pick-up orders.

It is common for retailers of goods and services to both own and/or operate one or more “brick-and-mortar” retail stores and/or physical facilities where customers may browse, purchase, and/or pick up items at the site, and also provide an online website or other service for receiving orders from customers remotely. Today's consumers demand convenience, speed, selection, and high-quality from their retailers regardless of whether such consumers are shopping online or are shopping in a brick-and-mortar establishment. Thus, in order to maximize customer satisfaction, a retailer must meet consumer expectations on these attributes when fulfilling items to a customer via customer pick-up.

A common method of facilitating customer pick-ups is by preparing retail items in a staging area, such as a warehouse, and storing them in containers, often referred to as “totes.” Prior totes are typically enclosed storage containers, and may comprise lids for accessing the retail items inside of the totes. Retail items in traditional totes are typically stored in stacked columns to efficiently use space in a staging area or other fulfillment location until the customer arrives to pick up the order. However, providing efficient pick-ups for the customer may prove difficult when customer arrival times are unpredictable. Retail items sitting on totes awaiting customer arrivals are “down-stacked” as additional items are loaded in the totes for pick-up. Thus, unless a customer's order is in a tote that sits at the top of a stacked column, un-stacking of totes may be required to get a specific tote or totes containing a customer's retail order. After a customer's order is retrieved and the down-stacked tote is extracted, the entire tote system must be re-stacked. Such down-stacking, un-stacking, and re-stacking leads to inefficiencies in fulfilling retail order pick-ups.

One method to avoid down-stacking may be to place the totes in perfect sequence based on customer pick-up times. However, a single delayed or off-scheduled customer arrival time can cause the down-stacking issues described above. Another method may be to use multi-level static shelves so that no down-stacking is needed to access a specific tote for the arrived customer. However, space in a warehouse or fulfillment area is often at a premium, and static shelves take up the same amount of space even when underutilized—that is, when fewer totes are required at a given time. This inflexibility may negatively impact space utilization within a staging area, warehouse, or retail location. Worse, when demand is higher than projected or more customers are arriving than expected at a given time, there may be an insufficient number of shelves to hold totes such that the retail pick-up flow is disrupted.

Furthermore, traditional totes are typically not clear or transparent. Without opening the lid, which would be difficult for any tote not at the very top of a column of totes, operators cannot visually inspect which totes contain retail items and which totes do not. An operator for a retail fulfillment location may be expected to lift a heavy tote, for example, up to 50 lbs, on the job, but without any visibility into the contents of a given tote, the weight of the tote may come as a surprise and the operator may sustain an injury or experience discomfort if the operator's body posture is not appropriate for the weight range of the tote.

Additionally, traditional enclosed totes may result in the degradation of retail items, for example, fresh produce that produce ethylene (e.g., bananas, avocados, peaches, etc.). Fresh produce items that produce ethylene may ripen more rapidly as ethylene gas is released and stays trapped inside the traditional totes. This could negatively impact product quality, especially in the summer where warmer temperatures speed up the production of ethylene gas, thus accelerating the ripening process of the produce items. Additionally, refrigerated or frozen retail items that sit on totes longer than expected in traditional tote systems may experience degradation of product quality.

Traditional totes also do not provide for “nesting” of totes on top of one another when the lids of such traditional totes are open. Thus, these traditional tote systems do not allow for reverse logistics during retrievals—that is, the down-stacking of empty return totes. The ability to nest totes within one another may allow for more efficient returns back to a warehouse or other staging area where additional totes are needed. Valuable space resources and personnel resources may be optimized by nestable totes.

### SUMMARY

The present disclosure generally relates to a tote system for facilitating more efficient retail order pick-ups.

In certain embodiments, a tote may comprise a bottom panel for supporting one or more retail items, a rear panel and a front panel, wherein the front panel may comprise an opening for accessing the one or more retail items of the tote, a first and a second side panel, and one or more bale arms positioned across a top of the tote, wherein the one or more bale arms may each comprise a substantially horizontal portion extending from the first side panel to the second side panel, such that the one or more bale arms are operable to support another tote stacked on top of the tote.

In certain embodiments, the tote may further comprise a substantially trapezoidal shape. In certain embodiments, the first side panel and the second side panel may be angled such that each of the first side panel and the second side panel form an obtuse angle with the bottom panel.

In certain embodiments, the one or more bale arms may be rotatable such that the one or more bale arms are not positioned across the top of the tote. In certain embodiments, each bale arm may comprise a first end and a second end positioned at opposing ends from one another. In certain embodiments, the second end may be wider than the first end. In certain embodiments, the first end may be angled more than 90 degrees from the horizontal portion of the bale arm, and the second end may be angled substantially perpendicular to the horizontal portion of the bale arm.

In certain embodiments, the tote may further comprise a first bale arm and a second bale arm, and wherein the first end of the first bale arm and the second end of the second bale arm are positioned along the first side panel, and wherein the second end of the first bale arm and the first end of the second bale arm are positioned along the second side panel. In certain embodiments, the first side panel and the second side panel of the tote may each comprise a hand hold.

In certain embodiments, a tote system may comprise two or more totes, including a first tote and a second tote, wherein each of the two or more totes may comprise one or more bale arms. In certain embodiments, the first tote and the second tote may be aligned substantially adjacent to one another, and at least one bale arm of the first tote may interlock with at least one bale arm of the second tote.

In certain embodiments, the two or more totes may each comprise a first bale arm and a second bale arm. In certain embodiments, the first bale arm and the second bale arm may each comprise a first end and a second end, wherein the second end is wider than the first end. In certain embodiments, the first end of the first bale arm of the first tote may interlock with the second end of the first bale arm of the second tote. In certain embodiments, the second end of the second bale arm of the first tote may interlock with the first end of the second bale arm of the second tote.

In certain embodiments, a tote system may further comprise a third tote stacked substantially on top of the one or more bale arms of the first tote and a fourth tote stacked substantially on top of the one or more bale arms of the second tote, and at least one bale arm of the third tote may interlock with at least one bale arm of the fourth tote. In certain embodiments, the tote system further comprises a pallet, wherein the two or more totes are positioned on the pallet.

In certain embodiments, a method for facilitating retail pick-up orders may comprise stacking two or more totes in a first column of totes via one or more bale arms of the two or more totes, wherein each of the two or more totes in the first column may have an opening such that an operator may place retail items while the two or more totes are stacked, stacking two or more totes in a second column of totes via one or more bale arms of the two or more totes, wherein each of the two or more totes in the second column may have an opening such that an operator may place retail items while the two or more totes are stacked, positioning the first and second column of totes adjacent to one another, interlocking one or more bale arms of a first tote in the first column with one or more bale arms of a second tote in the second column, wherein the second tote is immediately adjacent to the first tote; placing retail items in at least one of the two or more totes corresponding to one or more retail orders. In certain embodiments, each of the one or more bale arms may be positioned across a top of each tote of the two or more totes, such that a stacked tote may be substantially supported by the one or more bale arms of a tote immediately below the stacked tote.

In certain embodiments, the method for facilitating retail pick-up orders may further comprise removing one or more retail items from at least one of the two or more totes via the opening, wherein the one or more retail items correspond to one or more retail orders for customer pick-up. In certain embodiments, the method for facilitating retail pick-up orders may further comprise removing one or more retail items from the at least one of the two or more totes such that the at least one of the two or more totes is an empty tote, rotating the one or more bale arms of the empty tote such that the bale arms are not positioned across the top of the empty tote, and nesting the empty tote in another empty tote. In certain embodiments, the first column of totes and the second column of totes may each comprise six stacked totes.

In certain embodiments, the method for facilitating retail pick-up orders may further comprise stacking totes two or more totes in a third column of totes via one or more bale arms of the two or more totes, and interlocking the one or more bale arms of the second tote in the second column with one or more bale arms of a third tote in the third column of totes, wherein the third tote is immediately adjacent to the second tote. In certain embodiments, at least one of the two or more totes may comprise corrugated plastic.

### BRIEF DESCRIPTION OF THE FIGURES

For a more complete understanding of the present disclosure and its features and advantages, reference is now made to the following description, taken in conjunction with the accompanying drawings, in which:

FIG. 1A is a representation of a tote according to certain embodiments of the present disclosure.

FIG. 1B is a top view of a tote according to certain embodiments of the present disclosure.

FIG. 1C is a front view of a tote according to certain embodiments of the present disclosure.

FIG. 1D is a rear view of a tote according to certain embodiments of the present disclosure.

FIG. 1E is a first side view of a tote according to certain embodiments of the present disclosure.

FIG. 1F is a second side view of a tote according to certain embodiments of the present disclosure.

FIG. 2A is a front view of a bale arm of a tote according to certain embodiments of the present disclosure.

FIG. 2B is a first side view of a bale arm of a tote according to certain embodiments of the present disclosure.

FIG. 2C is a second side view of a bale arm of a tote according to certain embodiments of the present disclosure.

FIG. 2D is a rear view of a bale arm of a tote according to certain embodiments of the present disclosure.

FIG. 3A is a side-by-side tote configuration with pre-interlocking bale arms according to certain embodiments of the present disclosure.

FIG. 3B is a side-by-side tote configuration with interlocking bale arms according to certain embodiments of the present disclosure.

FIG. 4 is a representation of a stacked tote configuration according to certain embodiments of the present disclosure.

FIG. 5 is a representation of a tote system according to certain embodiments of the present disclosure.

FIG. 6 is a side-by-side tote configuration with interlocking bale arms according to certain embodiments of the present disclosure.

FIG. 7 is a representation of a nested tote configuration according to certain embodiments of the present disclosure.

While the present disclosure is susceptible to various modifications and alternative forms, specific example embodiments have been shown in the figures and are herein described in more detail. It should be understood, however, that the description of specific example embodiments is not intended to limit the invention to the particular forms disclosed, but on the contrary, this disclosure is to cover all modifications and equivalents as illustrated, in part, by the appended claims.

### DESCRIPTION OF EMBODIMENTS

Illustrative embodiments of the present disclosure are described in detail herein. In the interest of clarity, not all features of an actual implementation are described in this specification. It will of course be appreciated that in the development of any such actual embodiment, numerous implementation-specific decisions must be made to achieve the developers' specific goals, such as compliance with system related and business-related constraints, which will vary from one implementation to another. Moreover, it will be appreciated that such a development effort might be complex and time consuming but would nevertheless be a routine undertaking for those of ordinary skill in the art having the benefit of the present disclosure. Furthermore, in no way should the following examples be read to limit, or define, the scope of the disclosure.

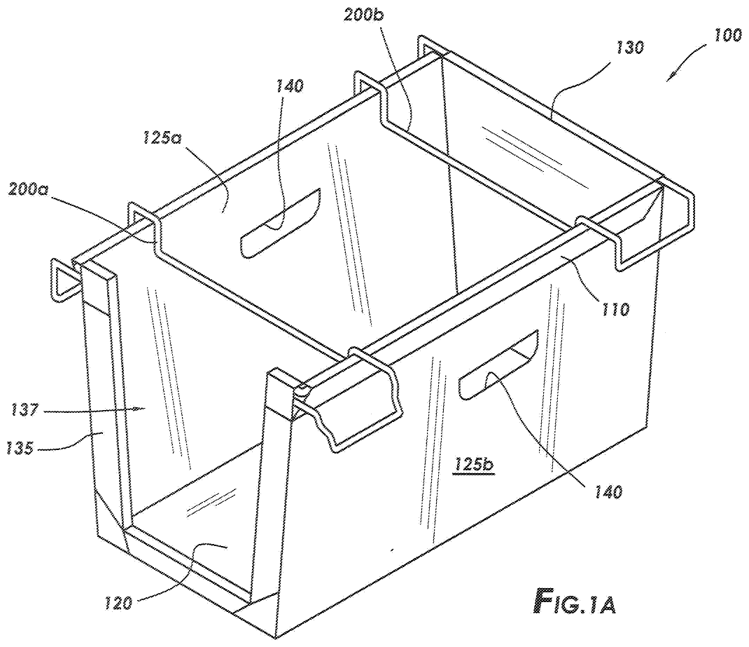

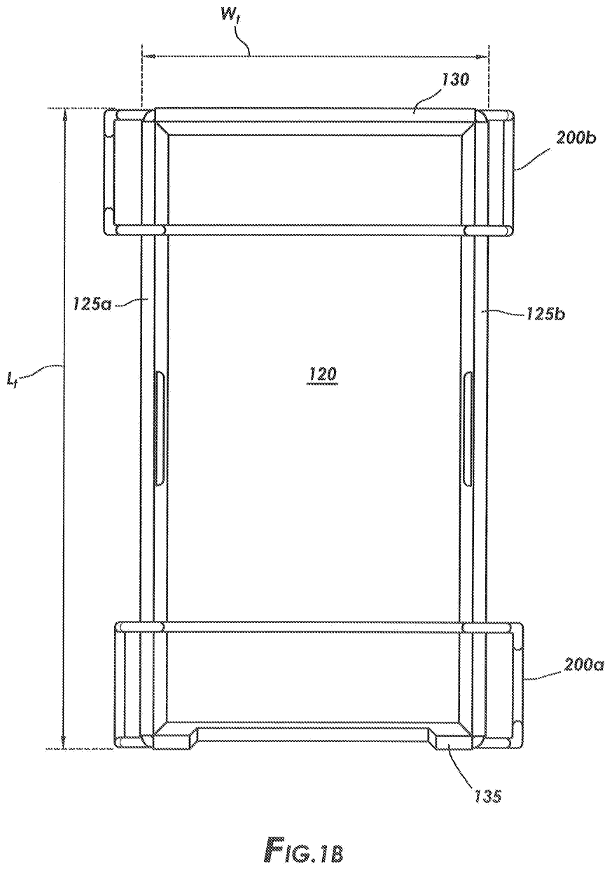

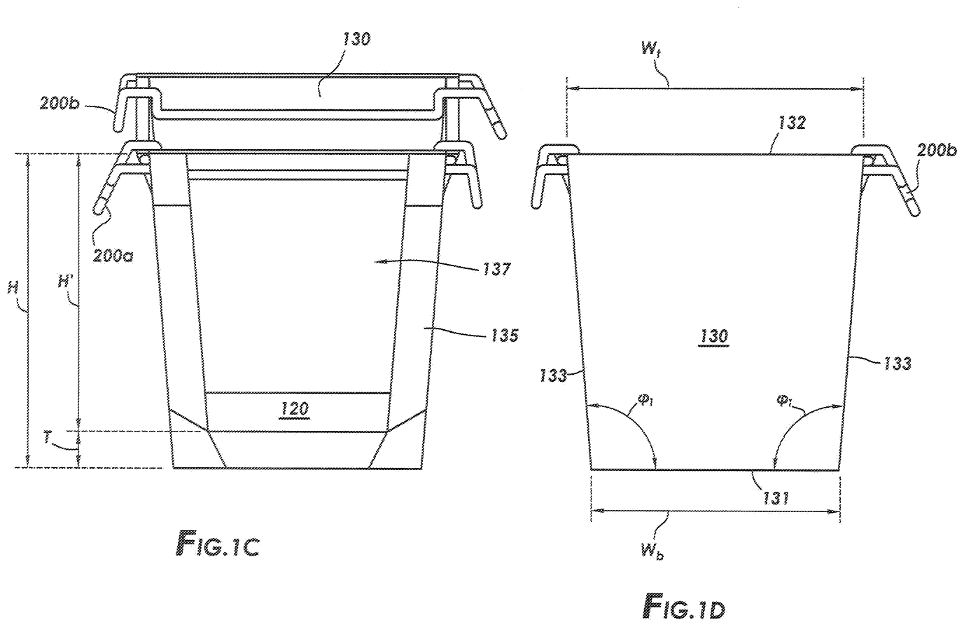

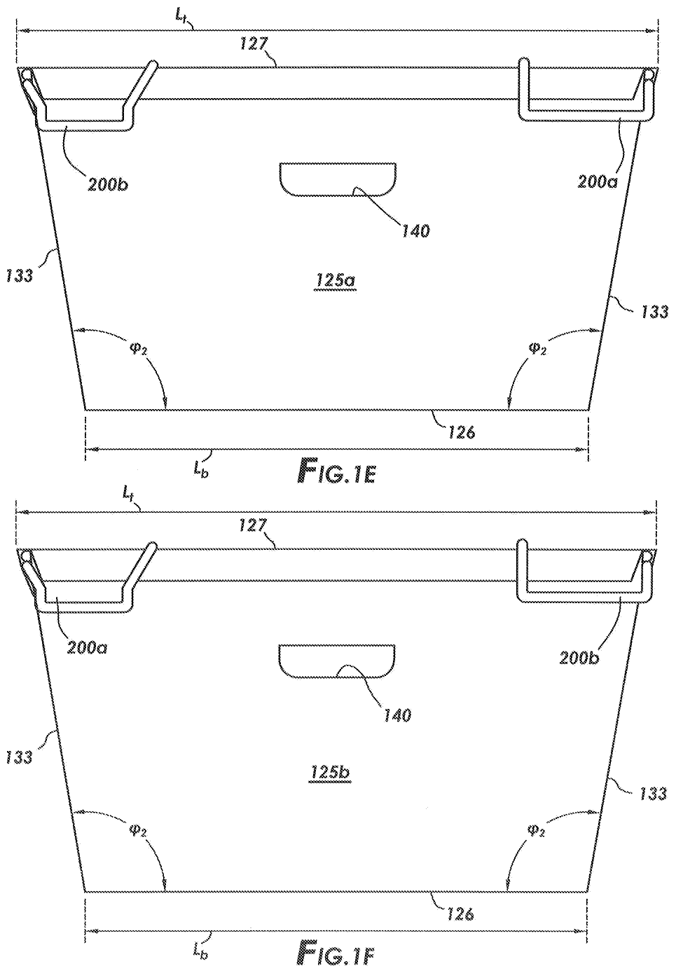

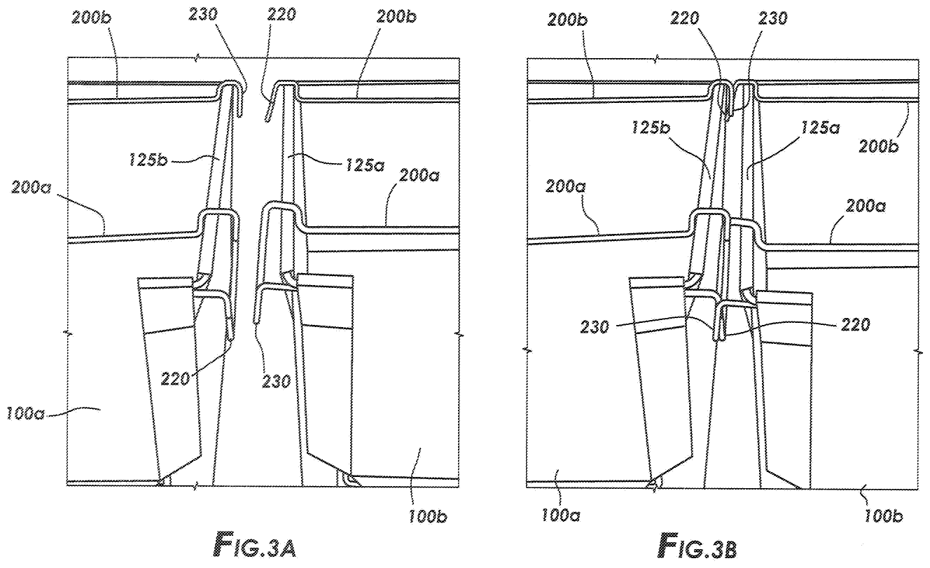

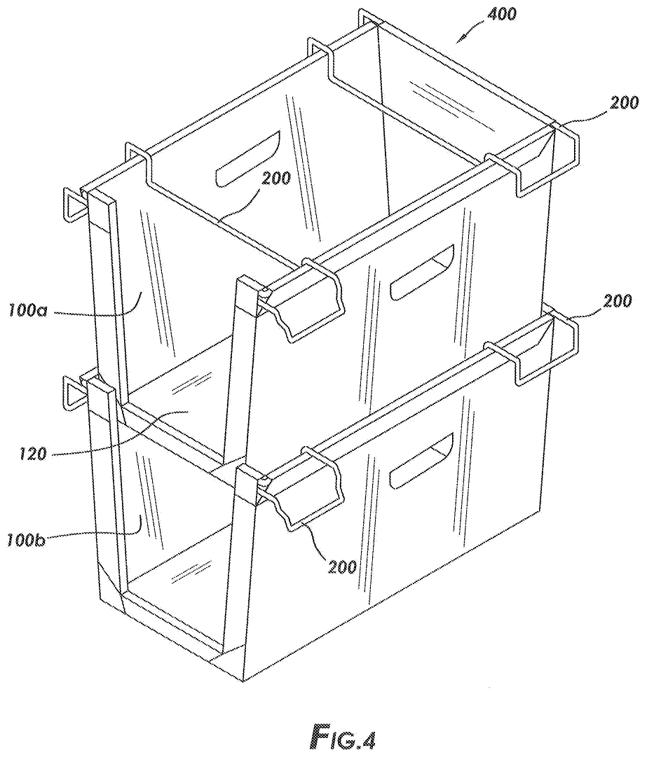

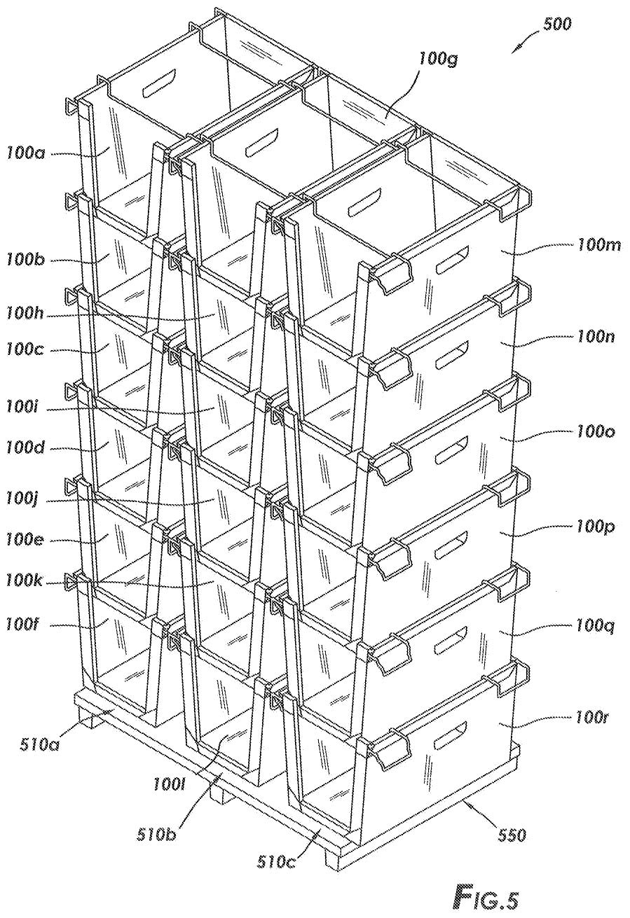

Referring now to FIG. 1A, a tote 100 is shown. A tote 100 may be comprised of any material suitable to store retail goods, including ambient and chilled retail goods. As would be understood by one of ordinary skill in the art, the material selected should be durable enough to withstand the stacking arrangement of totes 100 as described in more detail below with respect to FIG. 3. The material selected should be lightweight so as to be easy to lift and transport but also be substantially rigid to provide support for the retail goods stored in the tote 100. Furthermore, the material should be impact resistant such that damage to the tote 100 is minimized if a tote 100 is dropped or otherwise impacted. In certain embodiments, tote 100 may be comprised of plastic, for example, corrugated plastic or molded plastic. Corrugated plastic may be more flexible or agile than molded plastic because dimensions of corrugated plastic totes may be easily changed in production without building a new mold. Thus, corrugated plastic may be more easily adapted to fit the needs of a given retail space or fulfillment area, for example, if changes need to be made based on the size or volume of the corrugated plastic totes. The corrugated plastic may be comprised of solid polypropylene. In other embodiments, tote 100 may be comprised of other types of plastic, for example, tote 100 may be comprised of acrylonitrile-butadiene-styrene (ABS), acrylics, polyethylene (PE), high density polyethylene (HDPE), polypropylene (PP), & polyvinyl chloride (PVC), low-density polyethylene (LDPE), or any other type of plastic. Tote 100 may be pressed or formed from a single congruous piece of corrugated plastic, with or without the use of any adhesives. In other embodiments, tote 100 may be comprised of multiple pieces or layers of corrugated plastic formed together.

Tote 100 may be substantially rectangular or trapezoidal. In certain embodiments, tote 100 may comprise one or more flaps 110. In certain embodiments, the flaps 110 of tote 100 may be folded over and attached to the body of tote 100 using sonic welds. Welding the flaps may help keep bale arms 200a and 200b (discussed in more detail below) in place, while also increasing the longevity of the tote 100. In certain embodiments, flaps 110 of tote 100 may be secured using an adhesive (not shown). However, sonic welds may be more appropriate to withstand the force of the bale arms 200 as they are flipped inwards and outwards, or when the totes 100 are stacked or nested (discussed in more detail below). Furthermore, sonic welds may provide more stability to the tote 100, especially while being transported or otherwise handled by an operator.

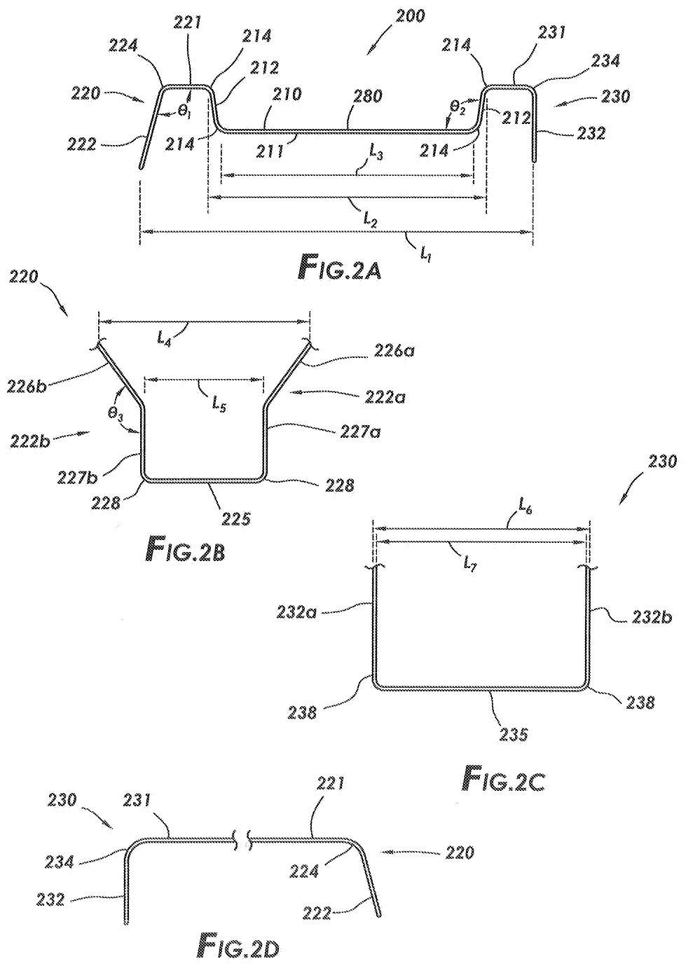

As shown in FIG. 1A, tote 100 may comprise a bottom panel 120, side panels 125a and 125b, and a rear panel 130. Side panels 125 may each comprise a hand hold 140 to facilitate easy transport of the tote 100. Tote 100 may further comprise a front panel 135 that is substantially comprised of an opening or window for inserting and removing goods from the tote 100. Tote 100 may further comprise one or more bale arms 200, for example, bale arms 200a and 200b, described in further detail with respect to FIGS. 2A-2D. One or more bale arms 200 may be partially enclosed by the tote 100, as shown in FIG. 1A. In certain embodiments, one or more bale arms 200 may be partially enclosed between the body of tote 100 and the flaps 110. In certain embodiments, each tote 100 may comprise a first bale arm 200a and a second bale arm 200b. A portion of bale arms 200 may sit across the top of tote 100 and extending between side panels 125, such that another tote 100, may sit or stack on first bale arm 200a and second bale arm 200b. As described in more detail below with respect to FIG. 3, the “stacked” nature of one or more totes 100 may provide for more structural stability of the tote system.

FIG. 1B is an overhead view of tote 100. Bottom panel 120 of tote 100 may support the retail goods in tote 100. In certain embodiments, bottom panel 120 may comprise a thicker material than other parts of the tote 100. For example, bottom panel may have an extra layer of corrugated plastic (not shown) to strengthen the bottom panel 120 and hold the weight of the retail items without deformation to the bottom panel 120 or the tote 100. An extra layer of corrugated plastic may be attached to bottom panel 120 by an adhesive or may be welded. The extra layer of corrugated plastic may be substantially smooth such that retail items placed on bottom panel 120 are not damaged during transportation or storage. The extra layer of corrugated plastic may comprise a substantially smooth surface so that bottom panel 120 is easier to sanitize.

Side panels 125 and rear panel 130 may substantially enclose the retail goods stored in tote 100 such that when subjected to movement, retail goods do not fall out of the tote 100. In certain embodiments, length Lₜ along the top of tote 100 may be approximately 24 inches and width Wₜ along the top of tote 100 may be approximately 13 inches. However, as would be understood by one of ordinary skill in the art, any length Lₜ or width Wₜ may be appropriate in keeping with the design features and benefits of the present disclosure. For example, in certain embodiments, length Lₜ of tote 100 may be 10-40 inches, and width Wₜ of tote 100 may be 5-25 inches. The length Lₜ and width Wₜ may be varied or selected based on one or more, for example, the size, weight, shape, or type of retail goods stored in tote 100. For example, for large or bulky retail items, a tote 100 with larger length and width dimensions may be required. Unlike traditional totes, tote 100 may not comprise a lid or panel covering the top of the tote 100. The lack of lid or cover may allow an operator to visually inspect what retail items are located in the tote 100 before lifting or moving the tote 100, such that the operator may use the appropriate body motion or posture before lifting or moving the tote 100.

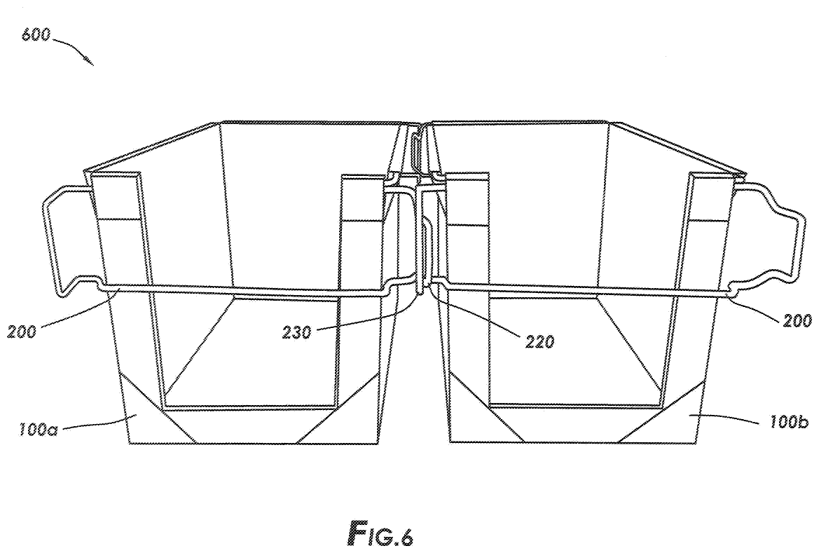

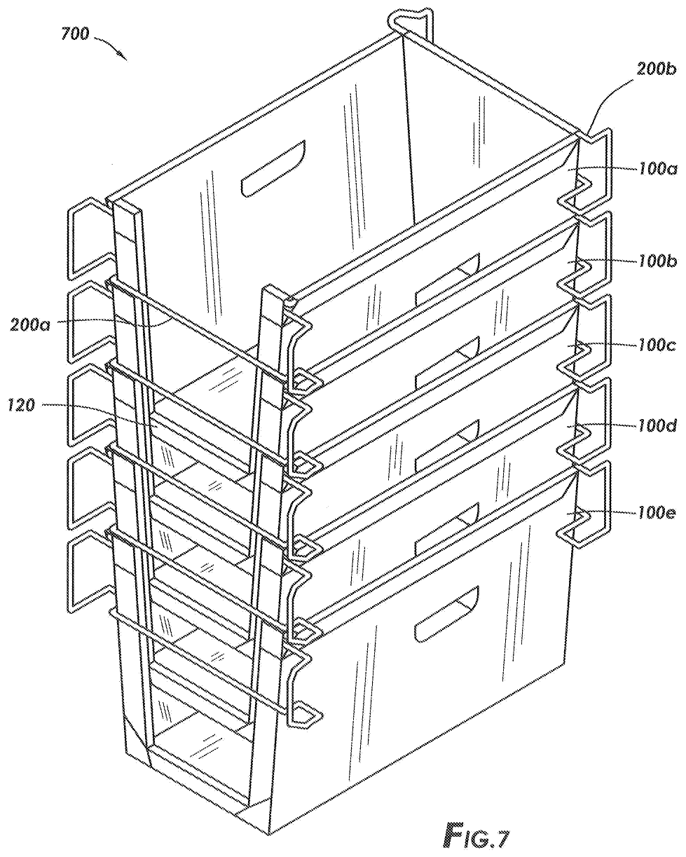

FIG. 1C is a front view of a tote 100 and FIG. 1D is a rear view of a tote 100. In certain embodiments, tote 100 may have a height H of approximately 12.75 inches. As would be understood by one of ordinary skill in the art, any height H may be appropriate in keeping with the design features and benefits of the present disclosure. For example, in certain embodiments, height H of tote 100 may be 5-25 inches. The height H may be varied or selected based on one or more factors, for example, the size, weight, shape, or type of retail goods stored in tote 100. For example, for tall items, a tote 100 with a larger height dimension may be required. In certain embodiments, tote 100 may be substantially trapezoidal in shape. In certain embodiments, front panel 135 and rear panel 130 may have a width Wₜ along a top edge 132 and a width W_{b} along a bottom edge 131, where Wₜ may be longer than W_{b}. For example, in certain embodiments where width Wₜ along top edge 132 is approximately 13 inches, width W_{b} along bottom edge 131 may be approximately 11 inches. Additionally, side edge 133 of rear panel 130 and front panel 135 may form an obtuse angle Φ₁ with bottom edge 131 that is slightly more than 90 degrees, for example, approximately 94 degrees. As would be understood by one of ordinary skill in the art, Φ₁, Wₜ, and W_{b} may be varied in keeping with aspects of the present disclosure. For example, in certain embodiments, Φ₁ may be 95, 100, or 105 degrees. In certain embodiments, the substantially trapezoidal shape of tote 100 may provide for stackable and nestable features of one or more totes 100, as described in more detail below with respect to FIGS. 4 and 7, respectively.

Front panel 135 may substantially comprise an opening 137 or window for placing and removing retail items from the tote 100. Additionally, the opening or window 137 of front panel 135 may allow an operator to visually inspect what retail items are in the tote 100 without removing the tote 100 from a stacked configuration, as described in more detail below. The opening or window 137 of front panel 135 may further allow an operator to determine the requisite amount of force and correct body posture for lifting the tote 100 based on the items contained with the tote 100. As shown in FIG. 1D, rear panel 130 may be a solid panel and may not be comprised of an opening or window 137. As would be understood by one of ordinary skill in the art, in certain embodiments, rear panel 130 may similarly comprise an opening or window 137 for placing or removing retail items from the tote 100, similar to front panel 135 (not shown).

The dimensions of tote 100 including height H and thickness T may be selected based on one or more factors such as the size, weight, shape, or type of the goods stored in tote 100. In certain embodiments, bottom panel 120 may have a thickness T of approximately 2.25 inches. As would be understood by one of ordinary skill in the art, any thickness T may be appropriate in keeping with the design features and benefits of the present disclosure. For example, in certain embodiments, thickness T of tote 100 may be 0.5 inch to 5 inches. The thickness T may be varied or selected based on one or more factors, for example, the size, weight, shape, or type of retail goods stored in tote 100. For example, for heavy or bulky retail items, a tote 100 with a larger thickness T may be required. In certain embodiments, the dimensions of tote 100 may be selected in order to hold a minimum weight of retail items. For example, dimensions of tote 100 may be selected such that tote 100 may be able to hold 10, 20, 25, 50, or 100 pounds of retail items without showing any signs of wear and tear on the tote 100.

The specific dimensions of tote 100 including height H and thickness T, may be varied or selected based on the desired height H′ of the opening of front panel 135. For example, as shown in FIG. 1C, a thickness T 2.25 inches of bottom panel 120 and a height H of 12.75 of front panel 135 inches renders a height H′ of 10.5 inches of the opening 137 of tote 100. Height H′ may be selected such that there is sufficient clearance for the retail items that are to be place in tote 100. As would be understood by one of ordinary skill in the art, height H′ may be varied based on one or more factors, for example, the size, shape, or type of the retail items to be stored in tote 100. In certain embodiments, height H′ may be anywhere from 5-25 inches.

FIGS. 1C and 1D are side views of tote 100. As discussed above, tote 100 may be substantially trapezoidal in shape. In certain embodiments, side panels 125 may have a length Lₜ along a top edge 127 and a length L_{b} along a bottom edge 126, where Lₜ may be longer than L_{b}. For example, in certain embodiments where length Lₜ along top edge 127 is approximately 24 inches, length L_{b} along bottom edge 126 may be approximately 21 inches. Additionally, side edge 132 of side panel 125 may form an obtuse angle Φ₂ with bottom edge 126 of approximately 97 degrees. As would be understood by one of ordinary skill in the art, Φ₂, Lₜ, and L_{b} may be varied in keeping with aspects of the present disclosure. For example, in certain embodiments, Φ₂ may be 95, 100, or 105 degrees. In certain embodiments, the obtuse angle Φ₂ and trapezoidal shape of tote 100 may provide for stackable and nestable features of one or more totes 100, as described in more detail below with respect to FIGS. 4 and 7, respectively.

In certain embodiments, tote 100 may comprise hand holds 140 at or near the top of side panels 125. For example, in certain embodiments, hand holds 125 may be located approximately 1-1.5 inches from the top of side panels 125. Hand holds 140 may facilitate easier transport of totes 100. Tote 100 may further comprise a label (not shown). A label (not shown) may comprise a barcode, stockkeeping unit number, universal product code (UPC), QR code, or any other identifier used to track or record the tote 100. For example, an employee of a retail store could scan the label of tote 100 to ensure that the tote 100 is in the correct location.

FIG. 2A is a front view of a bale arm 200 in accordance with certain embodiments of the present disclosure. In certain embodiments, one or more bale arms 200 may be welded in a tote 100. Bale arms 200 may be welded such that the bale arms 200 and tote 100 comprise one unitary structure. In certain embodiments, each bale arm 200 may weigh approximately 0.5 pounds. However, as would be understood by one of ordinary skill in the art, the weight of bale arm 200 may be varied or selected based on one or more factors, such as the size of the tote 100 or the size, weight, shape, or type of retail items to be stored in tote 100. In certain embodiments, bale arm 200 may be comprised of ¼ inch pre-galvanized steel wire. As would be understood by one of ordinary skill in the art, in other embodiments, other sizes, gauges, or material of wire may be appropriate. For example, in certain embodiments, bale arm 200 may be comprised of aluminum, stainless steel, or any metal or plastic. In certain embodiments, other materials and gauges that provide sufficient durability and strength to hold the weight of a tote 100 may be used.

Bale arm 200 may be comprised of a swing bar 210, a first end 220, and a second end 230. Swing bar 210 may be substantially horizontal and may be the primary portion of bale arm 200 used to support a tote 100 stacked on top of swing bar 210, as discussed in more detail with respect to FIG. 3. Swing bar 210 may comprise a base portion 211 and inclined portions 212. Inclined portions 212 of swing bar 210 may comprise arcuate portions 214 between swing bar 210 and first end 220 and swing bar 210 and second end 230, respectively. In certain embodiments, arcuate portions 214 may provide for an angle θ₂ of approximately 92 degrees between base portion 211 and inclined portions 212, as well as between swing bar 210 and first end 220 and between swing bar 210 and second end 230. Thus, in certain embodiments, inclined portions 212 may be substantially vertical and substantially perpendicular to base portion 211. In certain embodiments, the length L₁ of the bale arm 200 may be approximately 15 inches. In certain embodiments, the length L₂ of swing bar 210, including base portion 211 and inclined portions 212, may be approximately 12 inches. In certain embodiments, the length L₃ of base portion 211 of swing bar 210 may be approximately 11 inches. As would be understood by one of ordinary skill in the art, in certain embodiments, lengths L₁, L₂, and L₃ may be varied based one or more factors, for example the width Wₜ of the tote 100.

Swing bar 210 and first end 220, and separately, swing bar 210 and second end 230, may together each comprise a “U-shape” such that swing bar 210 and first end 220 and swing bar 210 and second end 230 each straddle a side wall 125 of tote 100. First end 220 may comprise an upper bar 221 and one or more side portions 222. Second end 230 may similarly comprise an upper bar 231 and one or more side portions 232. In certain embodiments, the length of upper bar 221 of first end 220 and upper bar 231 of second end 230 may be varied or selected based on the thickness of side panel 125. In other embodiments, the length of upper bar 221 of first end 220 and upper bar 231 of second end 230 may be selected such that there is a gap or space between first end 220 and second end 230 and side panel 125, respectively, so that an employee may hold or pick up the tote 100 using the first end 220 and 230. In certain embodiments, the length of upper bar 221 of first end 220 and upper bar 231 of second end 230 may be approximately 0.35 inches.

Second end 230 may further comprise an arcuate portion 234 between upper bar 231 and a side portion 232. In certain embodiments, arcuate portion 234 may provide for a substantially perpendicular angle between upper bar 231 and side portion 232, such that side portion 232 of second end 230 is substantially parallel to side panel 125 of tote 100. First end 220 may further comprise an arcuate portion 224 between upper bar 221 and side portion 222. In certain embodiments, arcuate portion 224 may provide for an angle θ₁ of approximately 105 degrees between upper bar 221 and side portion 222, such that side portion 222 of first end 220 is angled away from the side panel 125 of tote 100. In certain embodiments, side portion 222 of first end 220 may form an obtuse angle with the upper bar 221. As would be understood by one of ordinary skill in the art, the angles of arcuate portions 224 and 234 may be varied according to certain embodiments of the present disclosure.

FIG. 2B is a side view of first end 220 of bale arm 200 in accordance with certain embodiments of the present disclosure. In certain embodiments, first end 220 may be a narrower end of bale arm 200 compared to second end 230. As discussed with respect to FIG. 2A, first end 220 may comprise one or more side portions 222, for example, side portions 222a and 222b. One or more side portions 222 may each further comprise an angled portion 226 and vertical portion 227. Angled portions 226 of side portion 222 may be form an obtuse angle θ₃ of approximately 145 degrees from vertical portions 227 of side portion 222. As would be understood by one of ordinary skill, angle θ₃ may be varied based on one or more factors in keeping with aspects of the present disclosure. In certain embodiments, first end 220 may comprise a first side portion 222a and a second side portion 222b. First side portion 222a may comprise a first angled portion 226a and a first vertical portion 227a. Second side portion 222b may comprise a second angled portion 226b and a second vertical portion 227b. In certain embodiments, first angled portion 226a and second angled portion 226b may be different lengths such that angled portion 226a is longer than angled portion 226b. In certain embodiments, first vertical portion 227a and second vertical portion 227b may be different lengths such that second vertical portion 227b is longer than first vertical portion 227. For example, in certain embodiments, first angled portion 226a may be approximately 1.2 inches and first vertical portion 227a may be 0.8 inches, and in certain embodiments, second angled portion 227a may be approximately 0.8 inches and second vertical portion 227b may be approximately 1.2 inches.

First end 220 may further comprise a bottom bar 225 disposed substantially horizontally in between side portions 222, and more specifically, between vertical portions 227 of side portions 222. Bottom bar may be coupled to vertical portions 227 via arcuate portions 228. Similar to arcuate portions 214 of swing bar 210, arcuate portions 228 may provide substantially perpendicular angles between vertical portions 227 and bottom bar 225, such that bottom bar 225 and upper bar 221 are substantially parallel. In certain embodiments, the length L₄ of first end 220 may be approximately 2.8 inches, and the length L₅ of bottom bar 225 of first end 220 may be approximately 1.8 inches.

FIG. 2C is a side view of second end 230 of bale arm 200 in accordance with certain embodiments of the present disclosure. In certain embodiments, second end 230 may be a wider end of bale arm 200 compared to first end 220. As discussed with respect to FIG. 2A, second end 230 may comprise one or more side portions 232. In certain embodiments, second end 230 may comprise a first side portion 232a and a second side portion 232b. second end 230 may further comprise a bottom bar 235 disposed substantially horizontally in between side portions 232. Side portions 232 may be substantially vertical such that bottom bar 235 is substantially perpendicular to side portions 232. Bottom bar 235 may be coupled to side portions 232 via arcuate portions 238. Similar to arcuate portions 228, arcuate portions 238 may provide substantially perpendicular angles between side portions 232 and bottom bar 235. In certain embodiments, the length L₆ of second end 230 may be approximately 4.25 inches, and the length L₇ of bottom bar 235 of second end 230 may be approximately 3.25 inches.

Thus, in certain embodiments, second end 230 may be a wide end a first end 220 may be a narrow end, such that the second end 230 is wider than the first end 220. Furthermore, because first end 220 may be angled 105 degrees away from swing bar 210, a first end 220 may be configured to interlock with a second end 230, as described in more detail with respect to FIG. 3.

FIG. 2D is a rear view of bale arm 200 in accordance with certain embodiments of the present disclosure. From the rear view, swing bar 210 of bale arm 200 may be partially or substantially below the top of rear panel 130 of tote 100, such that swing bar 210 is not visible. Thus, in certain embodiments, only first end 220 and second end 230 of bale arm 200 may be visible from the rear view. As depicted in FIG. 2D, first end 220 may comprise a top bar 221 and a side bar 222. First end 220 may further comprise an arcuate portion 224 providing a substantially perpendicular angle between top bar 221 and side bar 222. In certain embodiments, side bar 222 may be approximately 1.2 inches and top bar 221 may be approximately 2 inches. Similarly, second end 230 may comprise a top bar 231 and a side bar 232. Second end 230 may further comprise an arcuate portion 234 for providing a substantially perpendicular angle between top bar 231 and side bar 232. In certain embodiments, the visible portions of second end 230 and first end 220 may be roughly equal. For example, in certain embodiments, side bar 232 may be approximately 1.2 inches and top bar 231 may be approximately 2 inches.

In certain embodiments, the unformed wire length of bale arm 200 may be approximately 35 inches and may weigh approximately 0.5 pounds. As would be understood by one of ordinary skill in the art, the weight and overall wire length of bale arm 200 may be varied according to the needs of the tote 100.

FIG. 3A depicts a side-by-side tote configuration with pre-interlocking bale arms in accordance with certain embodiments of the present disclosure. For example, as shown in FIG. 3A, a first tote 100a may be placed or disposed substantially adjacent to and aligned with a second tote 100b. In certain embodiments, a first tote 100a and a second tote 100b may be positioned such that a first bale arm 200a of first tote 100a is substantially aligned with a first bale arm 200a of a second tote 100b, and a second bale arm 200b of first tote 100a is substantially aligned with second bale arm 200b of second tote 100b. More specifically, the first end 220 of first bale arm 200a of the first tote 100a is substantially aligned with the second end 230 of first bale arm 200a of the second tote 100b. Further, the second end 230 of second bale arm 200b of first tote 100a is substantially aligned with the first end 220 of second bale arm 200b of second tote 100b.

FIG. 3B depicts a side-by-side tote configuration with interlocking bale arms in accordance with certain embodiments of the present disclosure. For example, as shown in FIG. 3B, a first tote 100a may be placed or disposed sufficiently close to a second tote 100b such that the first end 220 of first bale arm 200a of the first tote 100a overlaps and interlocks with the second end 230 of first bale arm 200a of the second tote 100b. More specifically, for example, the first end 220 of first bale arm 200a of first tote 100a may be threaded through the second end 230 of first bale arm 200a of second tote 100b, such that at least a portion of first end 220 of first bale arm 200a of first tote 100a is positioned in between side panel 125a of second tote 100b and at least a portion of second end 230 of first bale arm 200a of second tote 100b. Similarly, in the interlocked position, at least a portion of second end 230 of first bale arm 100a of second tote 100b may be positioned between side panel 125b of first tote 100a and at least a portion of first end 220 of first bale arm 200a of first tote 100a.

In a similar manner, as shown in FIG. 3B, the second end 230 of second bale arm 200b of first tote 100a may overlap and interlock with the first end 220 of second bale arm 200b of second tote 100b. More specifically, for example, the first end 220 of second bale arm 200b of second tote 100b may be threaded through the second end 230 of second bale arm 200b of first tote 100a, such that at least a portion of first end 220 of second bale arm 200b of second tote 100b is positioned between side panel 125b of first tote 100a and at least a portion of second end 230 of second bale arm 200b of first tote 100a. Similarly, in the interlocked position, at least a portion of second end 230 of second bale arm 200b of first tote 100a may be positioned between side panel 125a of second tote 100b and at least a portion of first end 220 of second bale arm 200b of second tote 100b. As would be understood by one of ordinary skill in the art, the interlocking of bale arms 200 between one or more totes 100 may be implemented in other ways, in keeping with aspects of the present disclosure.

FIG. 4 depicts a stacked tote configuration 400 of one or more totes 100, for example, a first tote 100a stacked on top of a second tote 100b, in accordance with certain aspects of the present disclosure. First tote 100a may be stacked on second tote 100b by placing the bottom panel 120 of tote 100a on bale arms 200 of the tote 100b directly below it. First tote 100a may be stacked on second tote 100b such that the bottom panel 120 of tote 100a fits on the swing bars 210 (not visible) of bale arms 200 of second tote 100b and fits snugly within the side panels 125, front panel 135, and rear panel 130 of second tote 100b. The stacked configuration 400 may provide for increased stability of both totes 100a and 100b.

In general, the stacked configuration 400 of one or more totes 100 may provide for increased stability of the one or more totes 100, for example, in a tote system 500 as described below with respect to FIG. 5. For example, in a busy warehouse or other retail staging area for fulfilment of pick-up orders, a tote 100 may be knocked over inadvertently by an employee or by a machine, causing delays in the fulfillment of retail orders. The stackable nature of the one or more totes 100 may reduce the likelihood that a tote will be knocked over or displaced, thus, improving the efficiency of fulfilling retail pick-up orders. Additionally, the stackable nature of one or more totes 100 may reduce the footprint required for the staging and storage of goods in a warehouse or staging area for retail fulfillment of pick-up orders. With the increased popularity of curbside pick-up and other types of customer pick-up orders, space in staging areas can be at a premium. The stackable nature of one or more totes 100 may allow for efficient use of floor space in a staging area, allowing for more orders to be processed and prepared in a shorter amount of time.

FIG. 5 depicts a tote system 500 in accordance with certain embodiments of the present disclosure. In certain embodiments, tote system 500 may comprise one or more totes 100, for example, totes 100a, 100b, 100c, 100d, 100e, 100f, 100g, 100h, 100i, 100j, 100k, 1001, 100m, 100n, 100o, 100p, 100q, and 100r. As would be understood by one of ordinary skill in the art, any number of totes 100, for example, totes 100a, 100b, 100c, . . . 100z, may be used in accordance with aspects of the present disclosure. In certain embodiments, tote system 500 may comprise 18 totes 100 in a 6×3 configuration as depicted in FIG. 5. For example, as shown in FIG. 5, tote system 500 may comprise three columns 510 each comprising six stacked totes 100. However, in certain embodiments, other tote configurations may be appropriate. For example, a tote system 500 may comprise 4 totes in a 2×2 configuration, 12 totes in a 3×4 configuration, or 25 totes in a 5×5 configuration. As would be understood by one of ordinary skill in the art, any number of suitable configurations may be selected based on a variety of factors, for example, the number of retail orders and the number of totes needed per retail order.

Each tote 100 may be stacked on one another by placing the bottom panel 120 of each tote 100 on bale arms 200 of the tote 100 directly below it, as described above with respect to FIG. 4. For example, tote 100a may be stacked on tote 100b by placing the bottom panel 120 of tote 100a on the swing bars 210 of bale arms 200 of tote 100b. Totes 100, for example, totes 100a, 100b, 100c, 100d, 100e, and 100f, may be stacked on top of one another such that there are, for example, six totes 100 stacked in a single column 310, of totes 100, for example in a first column 510a. Furthermore, as depicted in FIG. 3, totes 100g, 100h, 100i, 100j, 100k, and 1001 may be stacked on top of one another in a second column 510b, and totes 100m, 100n, 100o, 100p, 100q, and 100r may be stacked on top of one another in a third column 510c.

In certain embodiments, three columns 510 may be placed side-by-side with an equal number of totes 100 in each column 510. For example, columns 510a, 510b, and 510c each comprising six totes 100 may be placed side-by-side. In certain embodiments, columns 510a, 510b, and 510c may be placed sufficiently close to each other that totes 100 may interlock one or more adjacent totes 100. For example, first column 510a and second column 510b may be positioned sufficiently close together so that the totes 100a, 100b, 100c, 100d, 100e, and 100f of first column 510a are substantially aligned with totes 100g, 100h, 100i, 100j, 100k, and 1001 of second column 510b. Furthermore, each tote 100 of column 510a may interlock with each corresponding tote 100 of column 510b. For example, tote 100a may interlock with tote 100g by way of first end 220 of tote 101g overlapped or interlocked with second end 230 of tote 101a, as shown more clearly in FIGS. 3A and 3B. Thus, any movement or displacement of tote 100a may be suppressed by the interlocking arms of tote 100g. Similarly, movement of any totes 100 in first column 510a may be suppressed by the interlocking arms of the corresponding totes in second column 510b. The interlocking configuration of totes 100 in column 510a with totes 100 in column 510b may provide for increased stability of the tote system 500.

Similarly, a third column 510c may be positioned and aligned with second column 510b (and thus, also aligned with first column 510a) such that totes 100m, 100n, 100o, 100p, 100q, and 100r of third column 510c are substantially aligned totes 101g, 100h, 100i, 100j, 100k, and 1001 of second column 510b. Furthermore, each tote 100 of third column 510c may also interlock with each corresponding and adjacent tote 100 of second column 510b. For example, tote 100m may interlock with 100g by way of second end 230 of tote 100m overlapped with first end 220 of tote 101g, as shown more clearly in FIGS. 3A and 3B. Thus, any movement or displacement of tote 100g may be suppressed by the interlocking arms of tote 100m. Similarly, movement of any totes 100 in column 510b may be suppressed by the interlocking arms of the corresponding totes in column 510c. The interlocking configuration of totes 100 in column 510a with totes 100 in column 510b may provide for increased stability of the tote system 500.

The stackable and modular nature of one or more totes 100 may allow retail orders to be organized more efficiently and grouped together for faster retrieval. For example, one or more retail orders may be stored in one or more totes 100. The one or more totes 100 corresponding to a given retail order may be grouped in the same stack, for example, column 510a. Thus, an operator may be able to quickly identify the retail items for a given order based on the grouping of totes 100. As would be understood by one of ordinary skill in the art, a different grouping of totes 100 may correspond to a given retail order, for example, a row of totes 100. For example, based on one or more factors such as the size or number of items in a retail order, totes 100a, 100g, and 100m may correspond to a retail order. In certain embodiments, the entire tote system 500 may correspond to a retail order.

As would be understood by one of ordinary skill in the art, any number of tote systems 500 may be used in accordance with aspects of the present disclosure. For example, a warehouse or retail order fulfillment area may comprise 1, 5, 10, 20, or 50 tote systems 500. Furthermore, in certain embodiments, one or more tote systems 500 may each be placed on a pallet 550 for easy of transport such that an operator may be able to move the one or more tote systems 500 efficiently using a fork lift or other machinery. In certain embodiments, one or more tote systems 500 may fit on a single pallet 550. In certain embodiments, a pallet 550 may be 40″ wide by 48″ long. In certain embodiments, pallet 550 may allow two tote systems 500 or 36 totes 100 to fit thereon (not shown). The stackable and modular nature of totes 100 may provide flexibility in both the number of totes 100 in a given tote system 500, as well as the number of totes 100 on a pallet 550.

FIG. 6 depicts a side-by-side tote configuration 600 with interlocking bale arms in accordance with certain embodiments of the present disclosure. Similar to FIG. 3B, totes 100a and 100b may be placed or disposed sufficiently close together such that the first end 220 of bale arm 200 of a first tote 100a overlaps and interlocks with second end 230 of bale arm 200 of the second tote 100b. However, in certain embodiments, bale arms 200 of both totes 100 may be rotated such that each bale arm 200 is substantially in front of and to the rear of tote 100, rather than across the top of tote 100. For example, as shown in FIG. 6, a first bale arm 200a may be rotated (e.g., 90 degrees) such that the first bale arm 200a sits across front panel 135 of tote 100, and a second bale arm 200b may be rotated such that the second bale arm 200b sits across rear panel 130 of tote 100 (shown more clearly in FIG. 7). As described below in more detail with respect to FIG. 7, rotation of the bale arms 200 may allow for a “nested” configuration when retail goods are not being stored or held in the totes 100.

FIG. 7 depicts a nested configuration 700 of one or more totes 100, for example, totes 100a, 100b, 100c, 100d, and 100e, in accordance with certain aspects of the present disclosure. In certain embodiments, a “nested” configuration may be useful when the totes 100 are empty or otherwise not being used for storing or staging retail items for pickup. For example, a nested configuration of one or more totes 100 may be used when there is a surplus of totes 100 needed for fulfilling retail orders at a given time. Storing one or more totes 100 in a nested configuration may retain valuable space in a warehouse, staging area, or other retail space.

As described above, the trapezoidal shape of totes 100 may in certain embodiments, allow a first tote 100a to be nestable in a second tote 100b, such that the bottom panel 120 of the first tote 100a sits within the second tote 100b. One or more totes 100 may be nested within one another in accordance with one or more aspects of the present disclosure. For example, as shown in FIG. 7, 100a may be nested in tote 100b, tote 100b may be nested in 100c, tote 100c may be nested in 100d, and tote 100d may be nested in 100e. In certain embodiments, the distance between bottom panels 120 of respective totes 100 may be approximately 5 inches or less in a nested configuration. However, as would be understood by one of ordinary skill in the art, the distance between totes may vary based on the size and dimensions of totes 100. The number of nestable totes 100 may vary based on one or more factors, for example, the amount of available space in a retail fulfillment area, the number of retail orders needed to be fulfilled, the number of retail items needed to be staged, etc. In certain embodiments, any number of nested totes may be appropriate, for example, 5, 10, 15, or 20 totes 100 may be nested. In certain embodiments, the nestable totes 100 may be placed on a pallet 550 (not shown) for easy transport by a fork lift or other machinery.

Therefore, the present disclosure is well adapted to attain the ends and advantages mentioned, as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A tote, comprising:
a bottom panel for supporting one or more retail items;
a rear panel and a front panel, wherein the front panel comprises an opening for accessing the one or more retail items of the tote;
a first and a second side panel; and
one or more bale arms positioned across a top of the tote, wherein the one or more bale arms each comprise a substantially horizontal portion extending from the first side panel to the second side panel, such that the one or more bale arms are operable to support another tote stacked on top of the tote.

2. The tote of claim 1, wherein the tote is a substantially trapezoidal shape.

3. The tote of claim 1, wherein the first side panel and the second side panel are angled such that each of the first side panel and the second side panel form an obtuse angle with the bottom panel.

4. The tote of claim 1, wherein the one or more bale arms are rotatable such that the one or more bale arms are not positioned across the top of the tote.

5. The tote of claim 1, wherein each bale arm comprises a first end and a second end positioned at opposing ends from one another, wherein the second end is wider than the first end.

6. The tote of claim 5, wherein the first end is angled more than 90 degrees from the horizontal portion of the bale arm, and the second end is angled substantially perpendicular to the horizontal portion of the bale arm.

7. The tote of claim 5, wherein the tote comprises a first bale arm and a second bale arm, and wherein the first end of the first bale arm and the second end of the second bale arm are positioned along the first side panel, and wherein the second end of the first bale arm and the first end of the second bale arm are positioned along the second side panel.

8. The tote of claim 1, wherein the first side panel and the second side panel each comprise a hand hold.

9. A tote system, comprising:
two or more totes, wherein each of the two or more totes comprises one or more bale arms;
wherein the two or more totes comprise a first tote and a second tote, and wherein the first tote and the second tote are aligned substantially adjacent to one another; and
wherein at least one bale arm of the first tote interlocks with at least one bale arm of the second tote.

10. The tote system of claim 9, wherein the two or more totes each comprises a first bale arm and a second bale arm, the first bale arm and the second bale arm each comprising a first end and a second end, wherein the second end is wider than the first end.

11. The tote system of claim 10, wherein the first end of the first bale arm of the first tote interlocks with the second end of the first bale arm of the second tote, and wherein the second end of the second bale arm of the first tote interlocks with the first end of the second bale arm of the second tote.

12. The tote system of claim 9, further comprising:
a third tote stacked substantially on top of the one or more bale arms of the first tote and a fourth tote stacked substantially on top of the one or more bale arms of the second tote;
wherein at least one bale arm of the third tote interlocks with at least one bale arm of the fourth tote.

13. The tote system of claim 9, further comprising a pallet, wherein the two or more totes are positioned on the pallet.

14. A method of facilitating retail pick-up orders, comprising:
stacking two or more totes in a first column of totes via one or more bale arms of the two or more totes, wherein each of the two or more totes in the first column has an opening such that an operator may place retail items while the two or more totes are stacked;
stacking two or more totes in a second column of totes via one or more bale arms of the two or more totes, wherein each of the two or more totes in the second column has an opening such that an operator may place retail items while the two or more totes are stacked;
positioning the first and second column of totes adjacent to one another;
interlocking one or more bale arms of a first tote in the first column with one or more bale arms of a second tote in the second column, wherein the second tote is immediately adjacent to the first tote; and
placing retail items in at least one of the two or more totes corresponding to one or more retail orders.

15. The method of claim 14, wherein each of the one or more bale arms is positioned across a top of each tote of the two or more totes, such that a stacked tote is substantially supported by the one or more bale arms of a tote immediately below the stacked tote.

16. The method of claim 15, further comprising:
removing one or more retail items from at least one of the two or more totes via the opening, wherein the one or more retail items correspond to one or more retail orders for customer pick-up.

17. The method of claim 16, further comprising:
removing one or more retail items from the at least one of the two or more totes such that the at least one of the two or more totes is an empty tote;
rotating the one or more bale arms of the empty tote such that the bale arms are not positioned across the top of the empty tote; and
nesting the empty tote in another empty tote.

18. The method of claim 14, wherein the first column of totes and the second column of totes each comprise six stacked totes.

19. The method of claim 14, further comprising:
stacking totes two or more totes in a third column of totes via one or more bale arms of the two or more totes; and
interlocking the one or more bale arms of the second tote in the second column with one or more bale arms of a third tote in the third column of totes, wherein the third tote is immediately adjacent to the second tote.

20. The method of claim 14, wherein at least one of the two or more totes comprise corrugated plastic.
